(19) United States
(12) Patent Application Publication
(10) Pub. No.: US 2007/0031578 A1
(43) Pub. Date: Feb. 8, 2007

(54) Method for the preparation of frozen fish mass

(76) Inventors: Frode Bjorneset, Oslo (NO); Rune Neraal, Volda (NO)

Correspondence Address: DAVID A. GUERRA;INTERNATION PATENT GROUP, LLC, 2025 17TH AVENUE N.W., CALGARY, AB, T2M 0S7, CA

(21) Appl. No.: 10/595,176

(22) PCT Filed: Oct. 8, 2004
(86) PCT No.: PCT/NO04/00303

§ 371 Date: Mar. 17, 2006

(30) Foreign Application Priority Data
Oct. 9, 2003 (NO) 20034543

(51) Int. Cl. A23L 1/325

(52) U.S. Cl. 426/643

(57) ABSTRACT

A method for the preparation of frozen fish mass of white fish is described, suitable for use as strating material for the fish product industry, wherein the fish material provides improved binding and consistency forming properties through the addition of an organic acid or a salt thereof as well as a cryo-preservative.

The present invention concerns a method for treating ground fish meat that according to the method will be subjected to a freezing process, where one purpose of the method is to provide improved binding properties in the rethawed ground fish meat. The process is characterized in that the ground and not frozen fish meat is added a freezing stabilizer in addition to an organic acid.

### BASIC PROBLEM

The processing industry for fish products uses fresh or frozen raw materials of different types of fish. Traditionally cod, haddock and coalfish have comprises the main part of the foundation for the raw material. This fish have the best consistency properties for fish food in fresh condition, i.e. the ability to form a stable forcemeat fish product after extension with milk or water, and addition of other ingredients such as starch, spices and other typical ingredients for the production of food from fish.

The problem with traditional fish species is depletion, seasonal variations and high price often makes it barely economical and uncertain productionwise to found the production on fresh raw materials. Fresh raw material has good binding properties, but it is often difficult or impossible to provide fresh raw material so that most of the raw material that is used today becomes frozen on board in the fishing vessels or ashore for transport and frozen storage. Freezing often has a negative effect on the quality of the raw material and makes it poor or unsuitable as a production raw material for food from fish where there is set requirements for binding and consistency properties. The reason for this is that the fish proteins and cellular structure seems to become destroyed by the freezing process in such a way that many of the functional properties of the proteins are lost. This problem situation has for many years been known to the fish food industry without there seeming to be possible to find a stable solution to the problem.

White salmon has for the last few years been used as an alternative raw material, especially because it seems to tolerate the freezing process somewhat better than other fish-based raw material. The problem is that the fishing season is short so that it is put great demands on the freezing capacity for storage. White salmon also has a peculiar taste and is characterized by variable quality in the end product.

Blue whiting (Micromesistus poutassou) has usually not been considered as a fish for consumption but has been used for production of fish meal and animal feed. There is produced some surimi from blue whiting, but the product is characterized by the absence of binding properties as is wanted in extended fish forcemeat products. The degree of exploitation has been poor, usually around or less than 10%. Frozen meat from blue whiting has not binding properties that makes it suitable for the production of meat from fish. The reason is that the freezing process destroys the binding properties of the proteins.

The purpose of the present invention is to produce frozen surimi forcemeat blocks of white fish, exemplified by the use of blue whiting, wherein the frozen raw material has better binding properties than comparable frozen raw materials, surimi or surimi forcemeat products, and that is suitable for the production of food from fish.

### DISCLOSURE OF THE INVENTION

The above mentioned purpose is obtained according to the invention with a mixture of the fish raw material prior to freezing, and is characterized in that it comprises the addition of freezing stabiliser of the raw material in combination with an activation of the binding properties of the fish proteins. Such a treatment comprises the addition of freezing stabilisers (cryoprotectants) such as trehalose, in combination with said activation in the form of an addition of organic acids, e.g. lactic acid, or salts of organic acids, e.g. sodium, potassium or calcium lactate, or other organic acids or salts thereof. The organic acid is according to the invention a bioacceptable organic acid with a chain length of the carbon chain of between 1-10 atoms. The organic acid may be straight or branched, and it may be uni- or multi-valued. Examples of such acids will be formic acid, acetic acid, lactic acid, tartaric acid, succinic acid, malic acid, citric acid, pyruvic acid, lactic acid, etc.

The cryostabilisers may also be sorbitol, sucrose as well as other bioacceptable cryostabilisers or their derivatives. In addition there may be added salt di-, tri- or polyphosphates. These additions may also optionally be supplied with salts, such as e.g. sodium chloride, potassium chloride, magnesium chloride or they may also comprise native or modified starches, hydrocolloids, vegetable fibres, and animal or vegetable proteins, or products with a content thereof, to improve the binding properties and consistency of the end product.

Furthermore it may be possible to manipulate the consistency of the end product by adding varying amounts of liquid, e.g. water or aqueous fluids, to the fish product prior to its freezing. When thawing such a product with an increased content of liquid, it will be obtained an end product being somewhat looser in its consistency than the original surimi product. To such en products there may be added optional additives. Since the end product has a white colour, such additives may comprise colorants. The additives may also comprise taste additives such as additions of lobster, crab, shrimp, fish, bacon, meat or other type of taste additive. It may also be possible to use a looser product as a substitute for whole fish/fish filet, e.g. in fish fingers or the fish part in fish and chips.

Since the tenacity of the surimi product according to the invention is improved by the process, it will be possible to obtain a looser consistency of the end product by adding varying amounts of liquid. The product consistency may thus be regulated/varied through the aid of added amount of fluid prior to its freezing. Such a product may also be suitable for further production of panned fish products (e.g. fish croquettes).

Concerning the cryo stabilisers, this part will be present in an amount of 1.0% -12.0% (w/w). Concerning salts of the organic acids the addition(s) will be in an amount of 0.1% -6.0% (w/w).

### Publicly Available and Patented Processes for Producing Surimi and Fish Forcemeat Products

PCT/JP00/00970 of 21.02.00 discloses a process for treating fish meat and/or combined fish forcemeat comprising a high pressure treatment at low temperatures of frozen fish meat or fish meat product to improve sterility, texture and taste.

Publication NO 175243 of 07.04.89 concerns the production of minced meat, in particular fish, that is to be frozen by there being added sugar and/or a sugar alcohol with an oil or fat being dispersed on the cryoactive substance, in combination with phosphates.

Publication NO 140164 of 25.06.74 comprises a process for beaching fish meat with the maintenance of properties for fresh fish meat by adding dissolved esters of fatty acids and sugar alcohol or sucrose.

Publication NO 148907 of 04.12.79 comprises the production of ground fish meat to prevent a decrease of quality through pressing or grinding, by adding at least one compound selected from sorbitol, sucrose, sodium glutamate, sodium carbonate and sodium polyphosphate.

U.S. Pat. No. 5,344,665 of 06.09.94 comprises the production of frozen surimi that does not contain polyphosphates, but wherein there is added carbonates and/or bicarbonates in combination with salt of an organic acid from the group sodium citrate, calcium citrate, sodium acetate, calcium acetate, sodium tartrate, calcium tartrate and sodium gluconate.

U.S. Pat. No. 5,028,444 of 02.06.91 comprises a quality improvement of frozen surimi by adding a mixture of sodium bicarbonate, is calcium citrate and calcium lactate, in combination with sugar and/or sugar alcohols. The sugar may be selected from the group comprising sucrose, glucose, maltose, fructose, lactose, sorbitol, mannitol, xylitol, maltitol, lactitol or combinations thereof.

U.S. Pat. No. 4,176,202 of 27.11.79 comprises the replacement of fish raw material in kamaboko with a mixture of vegetable protein isolate and a fat emulsion.

U.S. Pat. No. 4,816,278 of 28.03.89 comprises the addition to inter alia fish of soy protein, oatmeal and starch.

U.S. Pat. No. 4,973,483 of 27.11.90 comprises freezing of fish forcemeat by the addition of sugar and/or sugar alcohol and/or an oil or fat dispersed on the cryoprotectant, with/without phosphates, optionally added starch or modified starches, cellulose and microcrystalline cellulose.

U.S. Pat. No. 5,456,938 of 10.10.95 comprises the production of surimi with the addition of a hydroxypropyl starch hydrolysate and/or a spheric dextrose (glucose) as a cryoprotectant.

U.S. Pat. No. 5,229,151 comprises the production of surimi that is improved in quality through the addition of calcium chloride and potassium chloride, optionally together with sodium chloride.

U.S. Pat. No. 4,910,039 of 20.03.90 comprises the production of frozen surimi with the addition of branched dextrins and a surfactant, especially to avoid bad smell after thawing.

### EXAMPLES OF THE PRODUCTION OF FISH FORCEMEAT ACCORDING TO THE PRIOR ART

Infra there are shown tests being conducted with surimi from blue whiting without stabilising, in comparison with is frozen raw materials from other fish species that are common to use in the production of fish food products. The tests are conducted with fish that previously have been decapitated and filleted. The fish meat was pressed through a holed disc and washed prior to introducing the additives in a blender. Subsequently the fish mass was formed to a block and frozen for storage at −18° C. or below. The tests were first conducted without a stabiliser to be able to evaluate the binding and treatment properties of the products. All the tests are carried out with the products fish balls and fish pudding.

First there was produced fish food with untreated, frozen raw fish material. The scheme shows the recipe and spreading degree for different fish raw material.

### Frozen Fish Forcemeat Without Additives

| | | |
|---|---|---|
| Surimi of blue | | Forcemeat of |
| whiting | White salmon | coalfish |

| | | | | | |
|---|---|---|---|---|---|
| Raw fish | 65 | Raw fish | 54.4 | Raw fish | 62 |
| material | | material | | material | |
| Milk | 15.6 | Milk | 24.8 | Milk | 19.2 |
| Starches | 6.4 | Starches | 6.8 | Starches | 6.5 |
| Soy oil | 5 | Soy oil | 6 | Soy oil | 6 |
| Soy | 3 | Soy | 2 | Soy | 2 |
| protein | | protein | | protein | |
| Spices | 3.5 | Spices | 4 | Spices | 3.1 |
| Salt | 1.5 | Salt | 2 | Salt | 1.2 |
| Sum | 100 | Sum | 100 | Sum | 100 |
| total % | | total % | | total % | |

The test shows that frozen blue whiting has the poorest binding properties, i.e. the poorest ability to bind added fluid, in relation to relevant alternatives such as forcemeat of white salmon and coalfish. Blue whiting is, on account of its poor tenacity properties, normally not considered as suitable for a fish raw material where there are present requirements for its extension.

### Stabilising Surimi Forcemeat from White Fish

By following the process according to the invention the fish raw material was treated as shown in the examples. Beforehand the fish had been decapitated end filleted. The fish meat was pressed through a holed disc and washed, before the additives were added in a blender. Then the fish material was formed into a block and frozen for storage at −18° C. or below.
1) There was added 8% trehalose, 3% sodium lactate and 0.3% tripolyphosphate.
2) There was added 4% trehalose, 4% sorbitol, 2% sodium lactate, 0.3% tripolyphosphate and 2% potato starch.
3) There was added 8% trehalose, 2% sodium lactate, 0.3% polyphosphate, 0.5% sodium chloride, 0.2% guar gum and 1% vegetable fibre.

The stabilising provides a surimi forcemeat which, subsequent to freezing and thawing, has very good tenacity properties, gives a solid consistency and is neutral in smell and taste.

Surimi is often produced by adding a cryoactive substance such as sucrose or sorbitol, in combination with phosphate and starch. In the example surimi of pacific whiting and of pollack is stabilised in such a way. Blue whiting is stabilised according to the invention, example no. 1.

Surimi forcemeat stabilised according to the invention has a tough sticky consistency. It has a neutral smell and taste, and has no sweet taste as may often be present in traditional surimi.

Surimi, or minced, frozen raw fish material in a block, produced in a traditional manner with or without stabiliser, often has a short or gritty consistency. During thawing frozen fish raw material may often prove to excrete large quantities of fluid as runoff, optionally after mechanical pressure. The binding and emulsifying properties are often limited.

A bacteriological examination of the stabilised forcemeat of blue whiting displayed a total germ number of 8.000/grams after thawing. The corresponding number for traditional surimi of blue whiting was 22.000/grams. The examination proved that surimi forcemeat stabilised according to the invention, obtains a reduced bacterial load and thus a reduced risk for bacteriological influence on proteins, fat and general quality reduction. In comparison it is common to set the requirement for a total germ number in surimi at 500.000/gram.

### Freeze-Stabilised Fish Forcemeat

There was produced fish forcemeat products, fishballs, fish cakes and fish pudding with traditional surimi and surimi forcemeat of blue whiting being stabilised according to the invention. The raw material was first frozen into blocks at −18° C., stored and then thawed again in connection with the production of fish food. The example shows the composition of the final fish forcemeat prior to heat treatment.

| | | |
|---|---|---|
| Stabilised surimi | | |
| forcemeat of blue | Surimi of Pacific | |
| whiting | whiting | Surimi of pollack |

| | | | | | |
|---|---|---|---|---|---|
| Raw fish | 32 | Raw fish | 44.4 | Raw fish | 42 |
| material | | material | | material | |
| Milk | 48.6 | Milk | 34.8 | Milk | 39.2 |
| Starches | 6.4 | Starches | 6.8 | Starches | 6.5 |
| Soy oil | 5 | Soy oil | 6 | Soy oil | 6 |
| Soy | 3 | Soy | 2 | Soy | 2 |
| protein | | protein | | protein | |
| Spices | 3.5 | Spices | 4 | Spices | 3.1 |
| Salt | 1.5 | Salt | 2 | Salt | 1.2 |
| Sum | 100 | Sum | 100 | Sum | 100 |
| total % | | total % | | total % | |

The example shows that with the one of stabilised surimi forcemeat of blue whiting there is made a product with the same or better and more solid consistency that with traditional stabilised surimi products, but with an addition of just 72-76% of the amount of raw fish material, and the degree of extension with milk that lies 26-40% higher. It was obtained similar results when the extension was done with water instead of milk. The extended fish forcemeat product proved to have a white colour and a neutral taste.

These tests show clearly that with a low input of fish raw materials and with a high degree of extension, this provides a basis for optimal functionality with a composition of the ingredients according to the invention. The stabilisation according to the invention of other fish species prior to freezing, such as e.g. Pacific whiting, Alaska pollack, white salmon, cod, etc. gives correspondingly good binding and consistency properties after thawing.

The process according to the invention shall additionally comprise the addition of di or tri polyphosphates. Furthermore the process according to the invention may comprise the addition of sodium, potassium or calcium chloride to the end product. The process according to the invention may furthermore preferably comprise the addition of one or more starches from potato, maize, tapioca, waxymaize or modified starches. Additional additives in the process according to the invention are the inclusion of one or more hydrocolloids such as guar gum, alginate, St. John's herb core flour, kojak flour and xanthan. It is also possible in the process according to the invention to add one or more vegetable fibres from wheat, oat, bamboo, cotton, leave trees or other vegetable raw materials, and it may also be possible in the process according to the invention to add one or more vegetable proteins and/or one or more animal proteins.

### Example of the Production of an End Product (Fish Fingers)

Based on the cryo-stabilised surimi product as produced supra, it was, prior to the freezing of the product, added about 50% by volume of additional liquid in the form of water to produce a porous end product. The produced surimi forcemeat is, subsequent to thawing, more porous than common surimi forcemeat (which is used for fish pudding, fish cakes, fish balls, etc.) and is well suited for products such as fish panettes, fish fingers, fish croquettes, etc.

The addition of liquid to produce a more porous end product may lie in the interval from the amount of liquid that normally provides a surimi product (see supra) and up to 200% by volume of this normally added amount of liquid.

1-13. (canceled)

14. A process for producing a fish meat product from ground fish with an increased degree of binding and consistency-forming properties, said process comprising the steps of:
grinding said fish meat;
matting said fish meat;
adding trehalose;
adding at least one salt of an organic acid; and
freezing said fish meat end product.

15. The process according to claim 14, characterized in that said salt of the organic acid is added in an amount of 0.1-6% (w/w) with respect to the weight of said end product.

16. The process according to claim 15, characterized in that said trehalose is present in an amount of 1.0-12.0% (w/w) with respect to the weight of said end product.

17. The process according to claim 16, characterized in that said salt of said organic acid is selected from the group consisting of a sodium-salt, potassium-salt, and calcium-salt, said salt has a maximum carbon chain length of 10 carbon atoms, wherein said organic acid may be straight or branched and may be single or multivalent, said organic acid is selected form the group consisting of lactic cid, citric acid, malic acid, acetic acid, and fumaric acid.

18. The process according to claim 17 further comprising the step of adding polyphosphates to said fish meat, said polyphosphates is selected from the group consisting of di-polyphosphates and tri-polyphosphates.

19. The process according to claim 18 further comprising the step of adding prior to said freezing of said ground fish meat a further amount of liquid in the form of a water-based fluid, in an amount of up to 200% by volume of the originally added amount of fluid.

20. The process according to claim 19 further comprising the step of adding chloride to said end product, where said chloride is selected from the group consisting of sodium chloride, potassium chloride, and calcium chloride.

21. The process according to claim 20 further comprising the step of adding starch to said end product, where said starch is selected from the group consisting of potato, maize, tapioca, waxymaize, and modified starches.

22. The process according to claim 21 further comprising the step of adding at least one hydrocolloid to said end product, wherein said hydrocolloid is selected from the group consisting of guar gum, alginate, St. John's bread core flour, kojak flour, and xanthane.

23. The process according to claim 22 further comprising the step of adding at least one vegetable fibre to said end product, wherein in said vegetable fibre is selected from the group consisting of wheat, oat, bamboo, cotton, leave trees, and vegetable raw materials.

24. The process according to claim 23 further comprising the step of adding at least one vegetable protein to said end product.

25. The process according to claim 24 further comprising the step of adding at least one animal protein to said end product.

26. The process according to claim 25, wherein said fish meat is selected from the group consisting of cod, haddock, coalfish, white salmon (silver smelt, Argentina sillus), blue whiting (Micromesistus poutassou), hake, Pacific whiting, red fish, trout, hoki, Pollack, and Atlantic Pollack.

27. A fish meat product with improved binding and consistency forming properties wherein the fish meat is subjected to a freezing and re-thawing process, said fish meat product comprising ground fish meat, trehalose, and an organic salt as a cryostabilizing substance

28. The fish meat product according to claim 27, wherein said fish meat is selected from the group consisting of cod, haddock, coalfish, white salmon (silver smelt, Argentina sillus), and blue whiting (Micromesistus poutassou), hake, Pacific whiting, red fish, trout, hoki, Pollack, and Atlantic Pollack.

29. The fish meat product according to claim 28, wherein said organic salt is in the amount of 0.1-6% (w/w) with respect to the weight of said fish meat product.

30. The fish meat product according to claim 28, wherein said trehalose is in the amount of 1.0-12.0% (w/w) with respect to the weight of said fish meat product.

31. The fish meat product according to claim 30, characterized in that said salt is of an organic acid and selected from the group consisting of a sodium-salt, potassium-salt, and calcium-salt, said salt has a maximum carbon chain length of carbon atoms, wherein said organic acid may be straight or branched and may be single or multivalent, said organic acid is selected form the group consisting of lactic cid, citric acid, malic acid, acetic acid, and fumaric acid.

32. The fish meat product according to claim 27 further comprising polyphosphate, a water-based fluid, chloride, starch, hydrocolloid, vegetable fibre, vegetable protein, and animal protein.

33. A frozen fish meat product comprising:
ground fish meat;
trehalose in the amount of 1.0-12.0% (w/w) with respect to the weight of said fish meat;
an organic salt as a cryostabilizing substance, said organic salt is of an organic acid and selected from the group consisting of a sodium-salt, potassium-salt, and calcium-salt, said salt has a maximum carbon chain length of 10 carbon atoms, wherein said organic acid may be straight or branched and may be single or multivalent, said organic acid is selected form the group consisting of lactic cid, citric acid, malic acid, acetic acid, and fumaric acid, wherein said organic salt is in the amount of 0.1-6% (w/w) with respect to the weight of said fish meat;
polyphosphate selected from the group consisting of di-polyphosphates and tri-polyphosphates;
a water-based fluid, in an amount of up to 200% by volume of the originally added amount of fluid;
chloride selected from the group consisting of sodium chloride, potassium chloride, and calcium chloride;
starch selected from the group consisting of potato, maize, tapioca, waxymaize, and modified starches;
at least one hydrocolloid selected from the group consisting of guar gum, alginate, St. John's bread core flour, kojak flour, and xanthane;
at least one vegetable fibre selected from the group consisting of wheat, oat, bamboo, cotton, leave trees, and vegetable raw materials;
at least one vegetable protein; and
at least one animal protein.
